(19) United States
(12) Patent Application Publication
(10) Pub. No.: US 2015/0036508 A1
(43) Pub. Date: Feb. 5, 2015

(54) Method and Apparatus For Gateway Selection In Multilevel SPB Network

(71) Applicant: Alcatel Lucent USA Inc., Murray Hill, NJ (US)

(72) Inventors: Donald W. Fedyk, Groton, MA (US); Senthil Sathappan, San Jose, CA (US); Simranjyot Suri, Sunnyvale, CA (US)

(73) Assignee: ALCATEL LUCENT, Paris (FR)

(21) Appl. No.: 13/955,404

(22) Filed: Jul. 31, 2013

(51) Int. Cl. H04L 12/721; H04L 12/801

(52) U.S. Cl. CPC H04L 45/124; H04L 47/12
USPC 370/238; 370/401

(57) ABSTRACT

A manner facilitating automatic selection of active gateway for communication between nodes in levels of a multilevel SPB network that adapts automatically to changes in network topology and allows autonomous operation within levels. When more than one node is eligible to act as the gateway, selection criteria, for example, a metric representative of the cost associated with choosing a node as gateway is used to select the active gateway.

### CROSS-REFERENCE TO RELATED APPLICATIONS

The present disclosure is related to U.S. patent application Ser. No. 13/231,588, entitled Method and Apparatus for Shortest Path Bridging of Multicast Traffic and filed on 13 Sep. 2011, the entire contents of which are incorporated by reference herein.

### TECHNICAL FIELD

The present invention relates generally to the field of communication networks, and, more particularly, to a method and apparatus facilitating selection of a gateway for communication between nodes in different levels of multilevel network, especially one operating according to an SPB (shortest path bridging) scheme.

### BACKGROUND

The following abbreviations are herewith defined, at least some of which are referred to within the following description of the state-of-the-art and the present invention.
BGP Border Gateway Protocol
BMAC Backbone MAC
ECT Equal Cost Tree
IEEE Institute of Electrical and Electronics Engineers
IETF Internet Engineering Task Force
I-SID service instance identifier
IS-IS Intermediate System to Intermediate System
LSP Link State Packet
MAC Media Access Control
OAM Operations Administration and Maintenance
PBB Provider Backbone Bridge
RFC Request for Comment [an IETF term]
SPB Shortest Path Bridging
SPF Shortest Path First
SPBM SPB MAC Mode
SPBV SPB VLAN ID
SPT Shortest Path Tree
SROS Service Router Operating System
TLV Type-Length-Value
VLAN Virtual Local Area Network
VPLS Virtual Private LAN Service

Data communication networks may be used to transport data between the myriad of computing devices that are now capable of sending and receiving data transmissions. In this way communications may be effected, information requested and retrieved, and graphical and video images transmitted just to cite a few examples.

Data communication networks may be implemented in a wide range of environments, from vast carrier networks to small home networks. Intermediate-sized communication networks may be deployed for example in business enterprises, on university campuses, and in data centers.

Unlike the traditional fixed hierarchical switching networks used, for example, for traditional telephone communications, modern communication networks typically are formed by a number of interconnected nodes variously referred to by such names as hubs, bridges, switches, and routers depending in part on their ability to receive and forward data. The communication network may change over time as nodes, or even sub-networks of nodes are added and removed.

A variety of operational protocols have been developed for organizing modern communication networks and directing the flow of data traffic through them. One such protocol is referred to as IS-IS (intermediate system to intermediate system). This protocol is described, for example, in IETF RFC 1142. IS-IS is a link state protocol, meaning the each of the nodes in the network acquire an understanding of the existence and interrelationship of some or all of the network nodes in order to calculate optimum data paths. Techniques are prescribed for network nodes to discover their neighbors, that is, the nodes to which they are connected, and to selectively advertise this information to the other nodes in the network.

One protocol that operates in such an environment is SPB (shortest path bridging), which governs how the network nodes obtain and use topology information to calculate paths throughout the network. SPB is gaining popularity as a successor to the STP (spanning tree protocol) family of protocols since SPB permits using multiple data paths through the network while still avoiding loops. SPB is described, for example, in the IEEE 802.1aq standard and is built using IS-IS.

A data communication network may be logically divided into sub-networks. There may be several reasons for doing this, one being the efficiency gained by reducing the amount of topology information that needs to be universally advertised; another is to permit the differentiation of behavior in different parts of the network. The IS-IS protocol permits multilevel networking, where adjoining networks can be delineated as level 1 and level 2. (Refer for example to FIG. 1.)

In a multilevel IS-IS communication network, a level 1 network and a level 2 network may, for example, implement different versions of SPB (varying, for example, in the behavior of some aspect of forwarding). As mentioned above, not all information advertised for the nodes of one level need be advertised to the nodes of the other level, reducing the control information exchanged. Data traffic that must pass from one level to another level passes through a gateway node, which includes a level 1 interface and a level 2 interface.

In many deployments, there are multiple gateway nodes that may be used to interconnect different sub-networks such as level 1 and level 2 networks. This topology is often desirable if for no other reason than redundancy if one gateway fails or is taken out of service. Where there are multiple gateway nodes between a level 1 and a level 2 network, however, it is sometimes advantageous to select a single active gateway node to handle traffic in both directions for at least a given subset of the traffic. For example, using a single active gateway for traffic in both directions may be advantageous for OAM in Ethernet and SPB networks and for interworking between different forwarding behaviors such as loop mitigation mechanism like ingress checks or reverse path forwarding checks. Single active gateway selection may be done using manual configuration, but it is preferable that the selection can be executed when needed by the nodes of the communication network with little or no need for operator intervention.

Needed then is a manner of facilitating selection of and selecting an active gateway for handling data traffic between a first level and a second level sub-network.

Note that the techniques or schemes described herein as existing, possible, or desirable are presented as background for the present invention, but no admission is made thereby that these techniques and schemes or the need for them were heretofore commercialized or known to others besides the inventors.

### SUMMARY

The present invention is directed to a manner of facilitating selection of an active gateway for communication between levels of a multi-level network. In a preferred embodiment the present invention provides for the automatic selection of a bi-directional gateway between nodes in levels of a multi-level network regardless of topology of the levels and adapts to changes in topology.

In one aspect, the present invention is a system of level 1 nodes and level 2 nodes interconnected at gateway nodes to form a multilevel network, wherein gateway nodes advertise to level 2 nodes external routes with a metric to a selected level 1 node and advertise level 1 nodes external routes with the system ID of the gateway, and wherein one active gateway node is chosen by the level 1 nodes and the level 2 nodes based at least in part on the advertised information. The information may be transmitted, for example, as TLVs in link state packets.

The selected level 1 node is preferably a central, well-connected node in the level 1 sub-network, for example the multicast root of a single tree. Note that in some embodiments the metric may be set to a fixed value.

In another aspect, the present invention is a method for selecting an active gateway in a multi-level communication network having a first level and a second level, the method in one embodiment including determining the available gateway nodes, determining a metric for each of the gateway nodes, the metric representative of the cost associated with the shortest path between a gateway node and a selected node associated with the level 1 sub-network, comparing the metrics of the gateway nodes, and selecting the active gateway based at least in part on the gateway node metric comparison. In some embodiments, the method includes selecting as the active gateway the gateway node with the lowest metric. In some embodiments, where it is determined that a plurality of gateway nodes have the lowest metric the method also includes selecting as the active gateway the gateway node of the plurality of gateway nodes that has the lowest numerical system ID number. Alternately, bridge priority may be used, or a combination of both.

In this aspect, the method of the present invention is preferably executed by a network node, and most or all of the nodes in a communication network preferably execute the method at about the same time.

In some embodiments, the present invention also includes selecting a level 1 node for determining the metric, for example using an ECT (equal cost tree) algorithm. The selected level 1 node may have to be selected from a plurality of multicast root nodes, for example using an ID or priority value. The method may then also include advertising to level 2 nodes at least one external route with a metric to the selected level 1 node and advertising to level 1 nodes at least one external route with a system ID associated with the advertising node. LSPs carrying TLVs may be used for this purpose.

In some embodiments, the present invention may include receiving and selectively storing advertised information, and also forwarding data traffic via the selected active gateway. The level 1 or level 2 network, or both, may be fully meshed but do not have to be. Networks may operate, for example, according to an SPF (shortest path first) protocol or Single Tree [reference] protocol. Preferably, in any level of the network the forwarding may operate on different principles than the other level of the network. This allows different SPB implementations to interwork and be redundantly connected.

In another aspect, the present invention is a network node including a processor and a memory device storing program instructions that when executed by the processor cause the network node to perform a method including determining the available gateway nodes between a level 1 sub-network and a level 2 sub-network, determining a metric for each of the gateway nodes, the metric for example representative of the cost associated with the shortest path between a gateway node and a selected node such as a multicast root associated with the level 1 sub-network, comparing the metrics of the gateway nodes, and selecting the active gateway based at least in part on the gateway node metric comparison. The network node may also include a routing table for selectively storing received gateway information for performing the method.

In some embodiments, the program instructions may also include instructions that when executed by the processor cause the network node to advertise selected information to level 1 network nodes and to level 2 network nodes, for example the metric representative of the cost associated with the shortest path between the network node and a selected node associated with the level 1 sub-network.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a multilevel communications network in which an embodiment of the present invention may be implemented;

FIG. 2 is a flow diagram illustrating a method of selecting an active gateway in a multilevel communication network according to an embodiment of the present invention;

FIG. 3 is a flow diagram illustrating a method of facilitating active gateway selection in a multilevel communication network according to an embodiment of the present invention; and

FIG. 4 is a simplified block diagram illustrating a network node configured according to an embodiment of the present invention.

### DETAILED DESCRIPTION

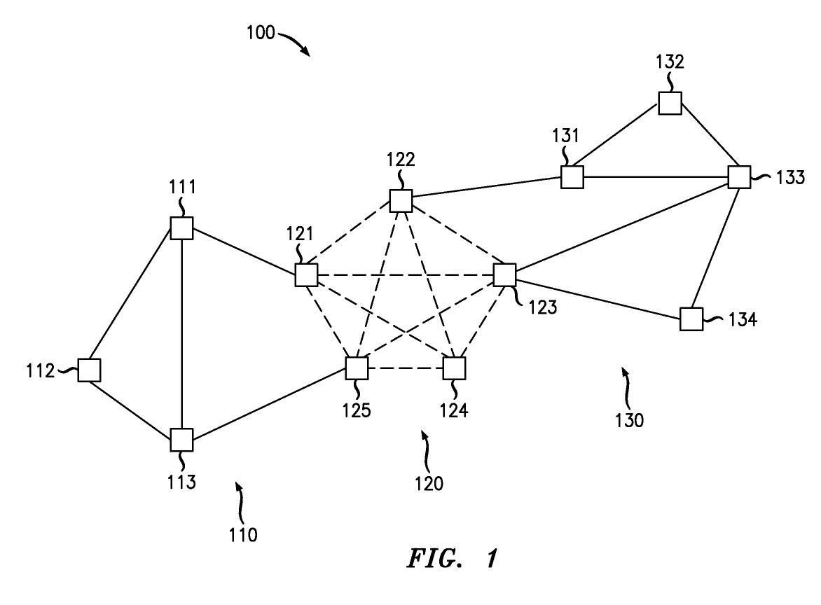

The present invention is directed to a manner of facilitating selection of an active gateway for communication between levels of a multi-level network. The selected gateway may then be used for all traffic, unicast and multicast. By forcing all traffic in an SPB instance to use a single gateway different forwarding behaviors can be supported in different levels of the network. Any gateways not selected may remain inactive unless and until a need to change configuration arises, such as the failure of a link or node. Note, however, that gateway selection is preferably on a per SPB instance or per bridging domain basis and other instances or bridging domains are not precluded from using the inactive gateway. The invention may be advantageously implemented in a multilevel IS-IS network, such as the network depicted in FIG. 1.

FIG. 1 is a simplified schematic diagram illustrating selected components of a multi-level communications network 100 in which an embodiment of the present invention may be implemented. Topographically, network 100 is divided into three sub-networks, referred to in FIG. 1 as 110, 120, and 130, respectively. In this embodiment, sub-networks 110 and 130 are edge networks and sub-network 120 forms the core of network 100.

In the embodiment of FIG. 1, sub-network 120 is the level 2 network of multi-level network 100 and includes nodes 121 through 125. As should be apparent, sub-network 120 is topologically a fully meshed network and includes four gateways, namely nodes 121 and 125, which border sub-network 110, and nodes 122 and 123, which border sub-network 130. Sub-network 120 is represented by a broken line in FIG. 1. Note each of the links in sub-network 120 is presumed to have a cost of 1, which is typical but not necessarily the case in all implementations.

In the embodiment of FIG. 1, sub-network 110 is not fully meshed but operates under an SPF framework. Sub-network 110 in this embodiment is a level 1 network and includes nodes 111, 112, and 113, as well as incorporating nodes 121 and 125, which are also gateway nodes providing access to sub-network 120. Note each of the links in sub-network 110 is also presumed to have a cost of 1, which again is typical but not necessarily the case in all implementations.

In the embodiment of FIG. 1, sub-network 130 is also not fully meshed and operates under an SPF framework. Sub-network 130 in this embodiment is a level 1 network and includes nodes 131, 132, 133, and 134, as well as incorporating nodes 122 and 123, which are also gateway nodes providing access to sub-network 120. Note each of the links in sub-network 130 is also presumed to have a cost of 1, which again is typical but not necessarily the case in all implementations.

A network of the general configuration shown in FIG. 1 may be found in many communication networks today, for example those using H-VPLS (hierarchical virtual private LAN service). As is preferred, there are two gateways (that is, available gateways) between each of the sub-networks; nodes 121 and 125 between sub-networks 110 and 120, and nodes 122 and 123 between sub-networks 120 and 130. As alluded to above, in a preferred embodiment the nodes of multilevel communication network 100 are operable to select one of the gateway nodes shared between a one sub-network and another to serve as the active gateway. This process will now be explained in greater detail.

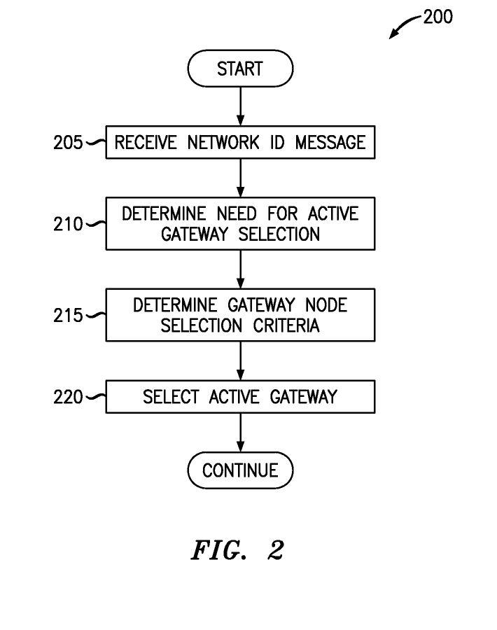

FIG. 2 is a flow diagram illustrating a method 200 of selecting an active gateway in a multilevel communication network according to an embodiment of the present invention. At START it is presumed that the necessary components are available and operational according to this embodiment. The process then begins with receiving at a node one or more messages advertising a network ID associated with a neighboring sub-network (step 205). Note that the network ID associated with a given level is preferably dynamically determined, for example according to node priorities; changes in network ID are in this case advertised. Static provisioning is not preferred because it may not properly address topology changes, for example a partition may cause multiple gateways to become active. In accordance with the present invention, gateway nodes between sub-networks (see, for example, nodes 121 and 125, and nodes 122 and 123 shown in FIG. 1) selectively advertise network ID information (not shown in FIG. 2), as will be described in greater detail below.

Note that as used herein, “advertise” refers broadly to transmitting topology or gateway selection information and includes re-originating received information.

In the embodiment of FIG. 2, the process then continues with determining that gateway selection is necessary (step 210). That is, the node receiving the one or more messages advertising a network ID receives from two different nodes the same network ID and a metric associated with the network ID, indicating that they are both (or all) gateway nodes with respect to the identified network. When this occurs, the value of first selection criteria associated each of the nodes advertising the common network ID is determined (step 215). The selection criteria may be, for example, a metric representative of the cost associated with the shortest path between a gateway node and a selected node associated with the level 1 sub-network, but other metrics may be used as well. The particular metric or metrics to be employed are imposed by the equipment manufacturer or the network operator or both, and in some implementations may be altered or adjusted.

In the embodiment of FIG. 2, an active gateway is then determined (step 220) by comparing the selection criteria associated with each of the gateways. (That is, each of the gateways advertising a common network ID.) In a preferred embodiment, the first selection criteria is a metric representative of the cost associated with the shortest path between a gateway node and a selected node associated with the level 1 sub-network associated with each gateway and the determination of step 220 is made by selecting the gateway associated with the numerically lowest metric. Other metrics may of course be used. In some cases, the first selection criteria used will not permit the gateway determination (for example, because the values being compared are equal), in which case a second (or additional, if necessary) criteria may be employed (not shown in FIG. 2).

Note that in most implementations, the gateway determination will be made by a network node within the network. Ideally, each node in the network makes a similar determination at approximately the same time using common criteria.

In determining available gateways and selection metrics, a network node may look to routing tables or similar tables stored in its own memory. The information populating such tables is received (not shown) from other network nodes, and particularly gateway nodes. In most cases therefore the the gateway node metric of the process of FIG. 2 will be determined from tables present on the node itself. The respective tables in or available to each participating node preferably form a common database for each level.

As mentioned above, in one embodiment the metric associated with a gateway node represents the distance or, more generally speaking, the cost, associated with the path between the gateway node and a selected level 1 node for the sub-network in question. The selected level 1 node may in some cases be a multicast root node of the level 1 sub-network, although other ways of selecting the level 1 node may be used as well, such as choosing the node with the lowest (or highest) system ID. As also mentioned above, this determination may be made by reference to routing or similar tables located within the node and populated with advertised information received after selection of the level 1 node. Here is it noted that the cost of individual links will in many cases be equal (for example a cost of 1) (refer, for example, to FIG. 1, described above), so the cost is equal to the number of hops although this could vary in other networks. A value associated with the selected level 1 node may be advertised as a network ID. As also mentioned above, the value of the metric may in some cases be fixed.

Note also that any determination indicated as being made on an individual node may be made outside of the node as well, presuming the availability of the necessary information and proper communication with the node itself, although this arrangement is not presently preferred.

If a second selection criteria is needed, the second selection criteria may be, for example, bridge priority value or bridge identity or both (choosing typically though not necessarily the lowest value). For example, metrics to each gateway, when used, may be equal, so additional selection driteria are in that case needed. Note that this means the network operator may influence gateway selection by assignment of priority (or other) values. Operator influence may also be asserted with the first selection criteria as well, depending on the metric employed.

In this manner, an active gateway is selected for communications passing between levels of a multilevel communication network. The active gateway may then be used until a change in topography necessitates another selection. Note that the active gateway is preferably one of two available gateways, which generally provides sufficient redundancy again failure of a link or node, but the method of the present invention may be applied to any number.

As should be apparent, application of the present invention requires that certain information be made available to each node, or at least to each network node or other entity at which the method of the present invention is to be performed.

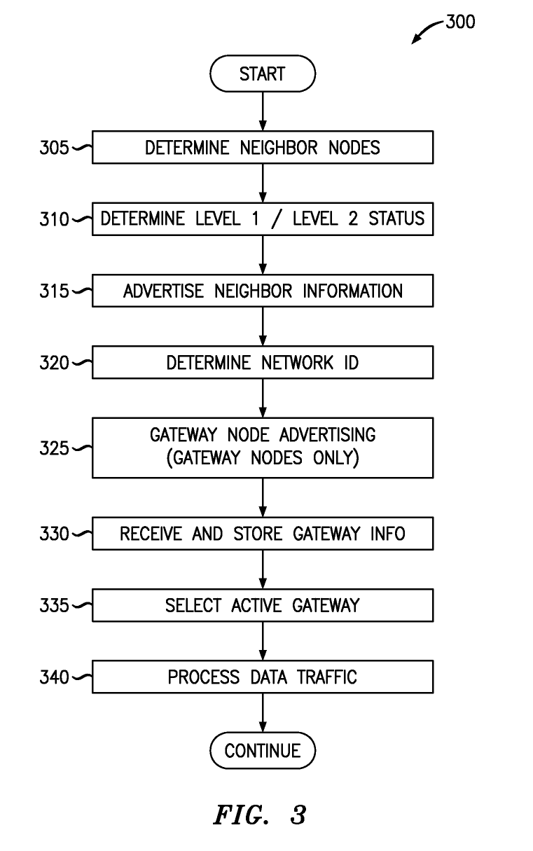

FIG. 3 is a flow diagram illustrating a method 300 of facilitating active gateway selection in a multilevel communication network according to an embodiment of the present invention. At START it is presumed that the necessary components are available and operational according to this embodiment. As with the process of FIG. 2, this method presumes that the steps are performed by all or most of the individual nodes in the communication network. The process then begins with determining the neighbor node or nodes (step 305). This may be done, for example, by execution of a discovery protocol or by reference to a configuration pre-programmed by a network operator. In similar fashion, the node determines (step 310) whether it is a level 1 node or a level 2 node, or both. If it is both, of course, it is a gateway node and eligible for selection as an active gateway. It will also advertise the gateway selection information in accordance with the embodiment of the invention that is being practiced, as described herein.

In this embodiment, the node advertises (step 315) the neighbor information to at least the other nodes within its sub-network. As mentioned above, in a link state protocol such as IS-IS, the neighbor node information is stored in an IS-IS database and in this way each node is aware of the topology of its network (or sub-network) and may perform calculations based on this awareness. A network ID for the sub-network is then determined (step 320).

In accordance with this embodiment of the present invention, gateway nodes, which have interfaces to both a level 1 sub-network and a level 2 sub-network, advertise (step 325) at least the information necessary for unambiguously determining an active gateway.

In making the active-gateway selection according to the present invention certain information is helpful or necessary. For this reason in a preferred embodiment, gateway nodes selectively advertise this information as will now be described in more detail. In most implementations, the information is transmitting in this fashion from every gateway node and received by each network node according to their level, although exceptions may be made in individual cases, for example if the network operator desires to enforce a certain solution.

In accordance with an embodiment of the present invention, each level 2 node with level one neighbors, that is, each gateway node, advertises information for active-gateway selection to all other nodes in the communication network. These transmissions may be sent, for example, as TLV messages in LSPs (link state packets). The advertising is selective in that certain information is sent to level 1 nodes while other information is sent to level 2 nodes. The advertising is typically but not necessarily performed after selecting a level 1 node such as a multicast root node, as described above.

In one embodiment, for example, a gateway advertises to level 2 nodes external root nodes with a metric to a selected level 1 node. That is, the metric is the distance (in hops) from the selected level 1 node to the advertising gateway. Note that in most implementations the cost of a link is presumed to be equal and can be assumed to be 1 for this description. If different costs are assigned to different links, the distance may be calculated based on the total cost rather than simply the number of hops. Reporting of the external root nodes preferably includes values for Network ID, BMACS and I-SIDS.

When used for gateway determination, the multicast root nodes may be determined by configured priority and by an ECT (equal cost tree) calculation, using tiebreakers if necessary. (For operation according to the present invention, a single root node is selected for a sub-network but multiple root nodes may be used with multiple gateways.)

In accordance with this embodiment, a gateway node which runs level 2 and level 1, advertises to level 1 nodes the external information from other gateways, but with the System ID of the gateway. In this way the level 1 nodes will select a gateway based solely on level 1 information.

In this embodiment, LSPs carrying the TLVs are forwarded normally according to IS-IS protocol. LSP redistribution should be allowed with minimum delay and no hiding of relevant TLV information (such as BMACs or I-SIDs in SPB)

The description above provides the advertising required for active-gateway selection according to this embodiment of the present invention, but this is not intended to imply that no other information may be advertised, or that different embodiments might not advertise different values in a different manner.

In an embodiment having a management BVPLS (backbone virtual private LAN service) supporting SAP (service access point) and SDP (service distribution point) binding, the following LSP advertisement rules apply. For each FID (forwarding identifier) on a level 1 management BVPLS:
All LSPs from level 1 are advertised to level 1 SPBM (SPB MAC mode) bindings of SAPs and SDPs. A level 1 BVPLS SAP-SDP binding does not listen to level 2 LSPs. Note that SAPs or SDP bindings cannot be level 1 and level 2 at the same time; and
All LSPs from level 1 SAPs and SDPs are exchanged as normal. If there are level 2 SAPs or SDP bindings the level 2 information is re-originated at the level 1 as external routes with the system-id of the level 2 root node.

In this embodiment, for each FID, a level 2 management BVPLS:
Re-originates all level 1 information learned from other interfaces at level 1 to level 2 only interfaces as external routes with a metric of the distance to the selected level 1 node;
Re-originates all learned level 2 information from other level 2 BVPLS at level 1 to level 1 BVPLS interfaces as external routes with the system ID of the level 2 root node;
Re-originates all level 1 information from other level 1 BVPLS at level 1 to level 1 BVPLS interfaces as external routes with the system ID of the level 2 root node; and
Sends level 2 LSPs with local BMACs and I-SIDs to level 2 neighbors.

In this embodiment, LSPs from a level 2 BVPLS to another level 2 BVPLS include all local level 2 node BMACs and I-SIDs, and in addition any BMACs and I-SIDs advertised from level 1 interfaces that are advertised as external routes. Note that a level 2 gateway advertises all level 2 information to the level 1 network as external routes with no metric; the external routes are identified with the root node of the level 2 network. This hides the topology information from the level 1 part of the network.

Returning to the embodiment of FIG. 3, when the advertised information is received at a node, it is selectively stored (step 330). Only the information necessary for gateway selection (or normal data forwarding) is retained. An active gateway may then be selected (step 335), applying the methodology described above in reference to FIG. 2, and normal data handling may continue (step 340).

Again, it is noted that although the process is described in terms of execution by a node, in most implementations it will be executed by most or of the nodes within the communication network (according to their role, for example, as a gateway node). It is not necessary that each and every node in a particular network or sub-network perform each of the steps of a given process according to the present invention unless explicitly recited in a particular embodiment or evident from the context.

Also note that the sequence of operation illustrated in FIGS. 2 and 3 represent exemplary embodiments; some variation is possible within the spirit of the invention. For example, additional operations may be added to those shown in FIGS. 2 and 3, and in some implementations one or more of the illustrated operations may be omitted. In addition, the operations of the method may be performed in any logically-consistent order or even simultaneously unless a definite sequence is recited in a particular embodiment. For example, any selection from a plurality of available gateways advertising the same network ID that uses the recited selection criteria of a particular embodiment is considered the literal performance of the method 200 described above.

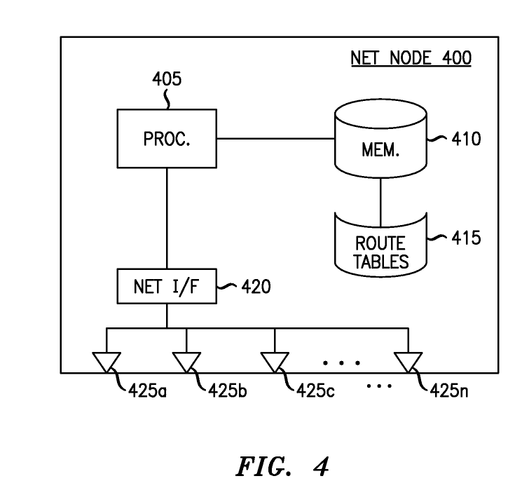

FIG. 4 is a simplified block diagram illustrating a network node 400 configured according to an embodiment of the present invention. In this embodiment, node 400 includes a processor 405 and a memory device 410. In a preferred embodiment, memory 410 includes a physical, non-transitory memory device for storing data and program instructions to for execution by processor 405 in performing some or all of the operations of the present invention such as those described above as methods 200 or 300. The memory is non-transitory in the sense that it is not merely a propagating signal. Shown separately is a routing table 415 for storing selected information relating to network topography for, among other things, selection of an active gateway by processor 405.

In the embodiment of FIG. 4, network node 400 also includes a network interface 420 for facilitating communication with a communication network such as network 100 shown in FIG. 1, and, if necessary, with other devices as well, via ports 425a through 425n. The processor 405 and network interface 420 are implemented in hardware or software executing on a hardware device, or a combination of both. In some embodiments the present invention includes software program instruction loaded into memory device 410 for execution by processor 405.

As an example, the communication network of FIG. 1 is a typical deployment having a meshed core operating as level 2 connecting two level 1 sub-networks operating according to SPF (shortest path first). In this example, distance to the multicast root node, mentioned above, is used as a gateway selection criteria. In this example, node 131 is the root node of sub-network 130 and node 121 is the root node of level 2 sub-network 120. When LSPs are transmitted, nodes 133 and 134 of sub-network 130 will receive LSPs with external root nodes from gateway node 123. They will also receive LSPs from node 122 via multicast root node 131. Node 122 is the active gateway between sub-network 120 and sub-network 130 (it has the lowest metric with respect to root node 131), and nodes 133 and 134 will only populate external routes from node 122 as the active gateway. Nodes 121, 123, 124, and 125 of sub-network 120 will also determine node 122 is the active gateway between sub-network 122 and sub-work 130, and all traffic between the two sub-networks will go through node 122.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for selecting an active gateway in a multi-level communication network that comprises a first level (level 1) and a second level (level 2), the method comprising:
determining that multiple gateway nodes are available to a common level 2 network identified by a network ID;
determining a selection criteria for each of the gateway nodes comparing the selection criteria of the gateway nodes; and
selecting the active gateway based at least in part on the gateway node selection criteria comparison.

2. The method of claim 1, wherein the first selection criteria is a metric representative of the cost associated with the shortest path between a gateway node and a selected level 1 node, and further comprising determining of the cost associated with the shortest path between a gateway node and the selected node associated with the level 1 sub-network.

3. The method of claim 2, wherein the selected node is the multicast root node associated with the level 1 sub-network.

4. The method of claim 9, further comprising selecting the level 1 multicast root node for determining the metric.

5. The method of claim 4, wherein the level 1 multicast root node is selected using an bridge priority and system ID.

6. The method of claim 5, wherein the level 1 multicast root node is selected from a plurality of multicast root nodes.

7. The method of claim 3, further comprising advertising to level 1 nodes at least one external route with a metric to the level 1 multicast root node.

8. The method of claim 7, where in the advertising is executed using TLV messages.

9. The method of claim 1, wherein the level 2 network ID is used to determine the eligible gateways and further comprising determining the level 2 network ID.

10. The method of claim 1, wherein the selection criteria comprises selecting as the active gateway the gateway node with the lowest selection criteria value.

11. The method of claim 1, further comprising determining that a plurality of gateway nodes have the lowest selection criteria value and selecting as the active gateway the gateway node of the plurality of gateway nodes that has the lowest numerical system ID number.

12. The method of claim 1, further comprising determining that a plurality of gateway nodes have the lowest selection criteria value and selecting as the active gateway the gateway node of the plurality of gateway nodes that has the lowest numerical bridge priority number.

13. The method of claim 1, wherein the determining and selecting steps are executed by a network node.

14. The method of claim 13, wherein the communication network level 1 comprises a plurality of network nodes and further comprising executing the determining and selecting steps by at least two of the network nodes.

15. The method of claim 14, wherein the at least two network nodes comprise all of the network nodes in the plurality of network nodes.

16. The method of claim 1, further comprising receiving advertising information prior to determining the selection criteria for each of the gateway nodes.

17. The method of claim 1, further comprising forwarding data traffic between the level 1 network and the level 2 network via the active gateway.

18. A network node, comprising:
A processor; and
A memory device comprising program instructions that when executed by the processor cause the network node to perform a method comprising:
determining multiple gateway nodes between a level one sub-network and a level two sub-network are available;
determining a first selection criteria for each of the gateway nodes;
comparing the first selection criteria of the gateway nodes; and
selecting the active gateway based at least in part on the gateway node selection criteria comparison.

19. The network node of claim 18, further comprising a routing table for selectively storing received gateway information for performing the method.

20. The network node of claim 19, wherein the program instructions further comprise instructions that when executed by the processor cause the network node to advertise selected information to level 1 network nodes and to level two network nodes.

21. The network node of claim 19, wherein the selected information comprises a metric representative of the cost associated with the shortest path between the network node and a selected node associated with the level 1 sub-network.

22. The network node of claim 21, wherein the selected node is a multicast root node associated with the level 1 sub-network.
